(19) United States
(12) Patent Application Publication
(10) Pub. No.: US 2006/0073004 A1
(43) Pub. Date: Apr. 6, 2006

(54) Bucket apparatus

(75) Inventors: Daniel C. Drexelius, Grand Island, NY (US); Brett J. Drexelius, Clarence, NY (US)

Correspondence Address: Vincent G. LoTempio, PO Box 820, East Amherst, NY, 14051, US

(73) Assignee: Bak Saver, LLC,

(21) Appl. No.: 10/948,903

(22) Filed: Sep. 24, 2004

(51) Int. Cl. B66C 23/00

(52) U.S. Cl. 414/719

(57) ABSTRACT

A bucket apparatus, removably attachable to a skid-steer loader, for transporting and dispensing flowable materials, such as concrete slurry, or particulate material, comprising a front wall, a rear wall, and opposing sidewalls defining at a top end thereof, a generally rectangular opening for the loading of flowable material. The opposing sidewalls are sloped, forming a hopper configuration terminating at the lower end, adjacent the lower end of the front wall, in a bottom exit opening and gate adapted for the controllable discharge of flowable material from the bucket. The gate may be manually controllable, pneumatically controllable, or hydraulically controllable.

### BACKGROUND OF THE INVENTION

1. Field of the Invention

This invention relates to a bucket apparatus attachable to a loader vehicle for receiving, holding, and dispensing flowable materials, such as granular materials, or slurries. More specifically, it is directed to a bucket apparatus that attaches to the front of various types of loader vehicles such as skid-steer loaders.

2. Background and Prior Art

When spreading flowable material, the material must cover a specific area, the pour site. Often, trucks transporting the material cannot reach the pour site due to their size. Furthermore, trucks are often unable to directly and efficiently distribute the material to the desired location. Therefore, wheelbarrows are typically used in such cases to transport and distribute the material to the pour site. However, the use of wheelbarrows requires substantial time and manpower. Wheelbarrows require many laborers, which may not always be as reliable as a machine. In addition, the use of wheelbarrows greatly limits the amount of material that can be transported from the truck to the pour site in a given period of time. Moreover, the cost of renting a truck is determined by the time of use at the site. Therefore, the quickest removal of the material from the truck is the most cost beneficial. However, to quickly remove the material using wheelbarrows requires many laborers. Also, if material is leftover after the job is complete, it is usually dumped as waste because it is difficult to return material back to the truck. Thus, wheelbarrows prove to be cost inefficient and wasteful in many cases.

There have been attempts to use loader vehicles with a typical bucket to deliver the material to a pour sight, however a disadvantage of a typical bucket is the inability to accurately distribute the material to a desired spot. The use of a typical bucket leads to spills and a faulty pour because there is no way to accurately direct portions of material to a specific area. Accordingly, a need exists for a dispensing apparatus that allows quick and easy transportation of flowable material to a pour site that overcomes the above drawbacks. Many prior attempts have been made to alleviate the problem associated with standard flowable material placement.

U.S. Pat. No. 5,692,875 to Boman discloses a chute assembly in a bucket or scoop designed to be mounted on a front end loader or the like having a boom or lift arms for raising, lowering and controlling fore-aft pitch of the bucket. The bucket or scoop has an interior chamber and the chute assembly has a pair of converging sidewalls mounted on a plate forming a funnel, preferably with an adjustable throat for spreading flowable materials. The sidewalls of the chute are adapted to make a sealing fit with the sidewalls of the bucket, as does the plate along its bottom wall, joining the funnel and the interior chamber and forming a hopper. This side wall opening is inefficient and cumbersome. The gate attachment control is dependent on the bucket control and is, thus, relatively imprecise.

U.S. Pat. No. 5,829,949 to Brown discloses a dispensing bucket apparatus that removably connects to a loader vehicle. The apparatus is a bucket that is adapted to receive and hold a flowable material and has an exit opening in its front end that is selectively opened and closed by a gate. The position of the gate may be controlled by the user from within the loader vehicle to control the flow and flow rate of the flowable material from the bucket. The sidewalls of the bucket converge toward the front of the bucket and form a funnel that directs the flowable material to the exit opening. However the exit opening on the side wall tends to cause the dispensing of a load to be imprecise and thus a cause of spillage and waste.

U.S. Pat. No. 4,798,510 to Lazenby discloses a concrete bucket assembly which is rigidly mounted for vertical, tilting, and rotational movement to a forklift vehicle. The concrete bucket is provided with upper and lower ball and socket assemblies. The lower ball and socket assembly secures the bucket to the extending fork of the vertically movable frame of the forklift truck. The upper ball and socket assembly secures the bucket, at the top thereof, to an arm which extends from and is pivotally secured to the vertically movable frame of the forklift vehicle. The arm which delivers the flowable material is cumbersome and difficult to use. This device is necessarily limited because the operator in the vehicle needs another person on the outside of the vehicle to direct the arm to the intended drop location.

U.S. Pat. No. 5,182,057 to Johnson discloses a method for the facile filling of remotely located forms with cementitious materials. The method uses a transportable bin which is captively coupled to the arms of a skid loader. The bin includes a generally rectangular container having four vertical sides and an accessible interior truncated at a base and having a covered dispensing aperture at the bottom. The covered aperture is adapted to be actuable by the skid loader operator using controls located within reach of the operator when the aperture is vertically disposed over a form to be filled.

### SUMMARY OF THE INVENTION

It is an object of the present invention to provide a dispensing bucket apparatus suitable for attachment to a loader vehicle for the transport and discharge of flowable materials.

It is a further object to provide a dispensing bucket apparatus removably attachable to a loader vehicle such as a skid-steer vehicle.

It is a still further object to provide a dispensing bucket apparatus for removable attachment to a loader vehicle having a controllable bottom exit opening and gate to permit the controllable discharge of flowable material therefrom, controlled by the loader vehicle operator.

It is another object to provide a dispensing bucket apparatus for removable attachment to a loader vehicle having bottom exit opening with a sliding self cleaning gate to permit the controllable discharge of flowable material therefrom.

It is a further object to provide a bucket apparatus that will facilitate the transport and dispensing of flowable materials, especially concrete slurries, at pour sites that are inaccessible to larger trucks and/or cement mixers.

It is an even further object to provide a bucket apparatus that will permit the transfer of concrete from a cement mixer, or other large source to a remote pour site with a minimum of manual labor.

It is a further object to provide a bucket apparatus that can be detached from a loader vehicle at a pour site and left in a free-standing mode.

It is still a further object to provide a bucket apparatus that will eliminate the waste of excess flowable materials, especially concrete slurries, by returning the excess material into trucks and/or cement mixers.

These and other objects are achieved in accordance with the present invention which provides a bucket, removably attachable to a loader vehicle, such as a skid steer vehicle for the transport and discharge of flowable materials, comprising a front wall and opposing rear wall, and opposing sidewalls defining, at a top end thereof, a rectangular opening for the loading of flowable materials; the opposing sidewalls, in at least a lower portion thereof, being sloped to form a hopper configuration terminating at a lower end in a bottom exit opening adapted for the controllable discharge of flowable materials from the bucket.

The rate of discharge of flowable materials from the bottom exit opening is controlled by a horizontal sliding gate across the exit opening, the sliding gate, in turn, being controllable manually, pneumatically, or hydraulically by an operator of the loader vehicle.

In a preferred embodiment, the hydraulic operation of the sliding gate is conveniently controllable by the operator by means of an auxiliary control without the need for the operator to leave the cab of the vehicle.

The bucket may be conveniently transported by a loader vehicle, from supply source, such as a cement mixer, to a remote pour site, and held by the vehicle while the concrete slurry is poured or alternatively, the bucket may be detached from the loader vehicle at the pour site, and left in a free-standing mode, on the leg members, while the loader vehicle is used for other tasks.

In an optional embodiment, the leg members of the bucket apparatus may be adjustable in height to allow the bucket to adapt to variously oriented pour sites. The adjustable height of the legs allows for various auxiliary devices to be attached to the bottom of the bucket, such as a salt dispenser and the like.

### BRIEF DESCRIPTION OF THE DRAWINGS

The present invention and the manner in which it may be practiced is further illustrated with reference to the accompanying drawings wherein:

FIG. 1 is a front perspective view of a bucket apparatus in accordance with the present invention shown attached to the arms of a skid-steer loader.

FIG. 2 is a side view of an embodiment of a bucket apparatus of the invention attached to the arms of a skid-steer loader.

FIG. 3 is a rear view of a bucket apparatus in accordance with the present invention.

FIG. 4 is a is a side view of an embodiment of a bucket apparatus of the invention attached to the arms of a skid-steer loader illustrating the hydraulic controls of the exit opening.

FIG. 5 is a bottom view of an embodiment of a bucket apparatus of the invention attached to the arms of a skid-steer loader illustrating the exit opening.

FIG. 6 is an enlarged view of gate and gate control of a bucket apparatus of the invention, taken generally along line 6-6 in FIG. 1.

FIG. 7 is a cross sectional view of a bottom of an embodiment of a bucket apparatus, taken generally along line 7-7 in FIG. 6.

### DETAILED DESCRIPTION OF THE INVENTION

This application claims priority of U.S. Provisional Patent Application 60\506429, filed on Sep. 26, 2003, titled: BUCKET APPARATUS.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

Loader vehicles, as used herein, include “skid-steer” loaders, backhoes, forklifts, sky-lifts, track-hoes, tractor loaders and other vehicles that include a hydraulic or pneumatic system and that are capable of removably receiving an attachment thereon. The bucket apparatus 10 is removably attachable to various loader vehicles quickly and easily. The apparatus is a bucket that is adapted to receive and hold a flowable material and has a hydraulically controlled exit opening 20 on the bottom surface thereof. “Flowable material” includes any material that is capable of flowing or moving through the relatively narrow exit opening. Examples of flowable materials include, inter alia, concrete, blacktop, stone, rock salt, mud, sand, dirt, rocks, stones, grain, feed, nuts, bolts, nails, and the like. Exit opening 10 may be manually operated using a latch or remotely controlled by the user from within the loader vehicle to control the flow rate of the material from the bucket. Sidewalls 16 of the bucket converge toward the bottom of the bucket to form a funnel that directs the flowable material to exit opening 20. The construction of the apparatus is such that the user can easily and accurately direct the flow of the material at all times and thereby, reduce spillage and waste.

The bucket apparatus can do the same job quicker and more accurately than many laborers with wheelbarrows. Also, this one machine eliminates the possibility of human error associated with many people doing the same job. It requires the work of only one semi-skilled worker to operate. The dispensing apparatus is able to pour excess material back into the truck. Also, it can accurately dispense material to the desired place because of the small hydraulically controlled exit opening in which the operator uses an auxiliary control to maintain the adequate flow rate, therefore leading to less waste.

The bucket apparatus includes a universal system allowing attachment to any loader vehicle used in such operations. Additionally, bucket apparatus 10 having a hydraulically controlled exit chute can universally connect to any front loader vehicle.

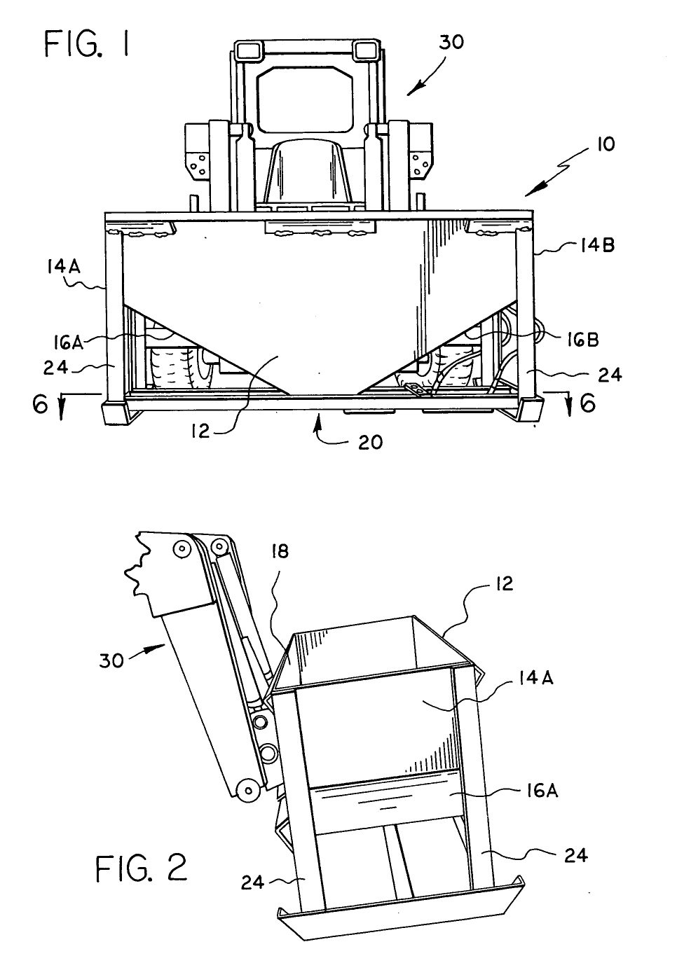

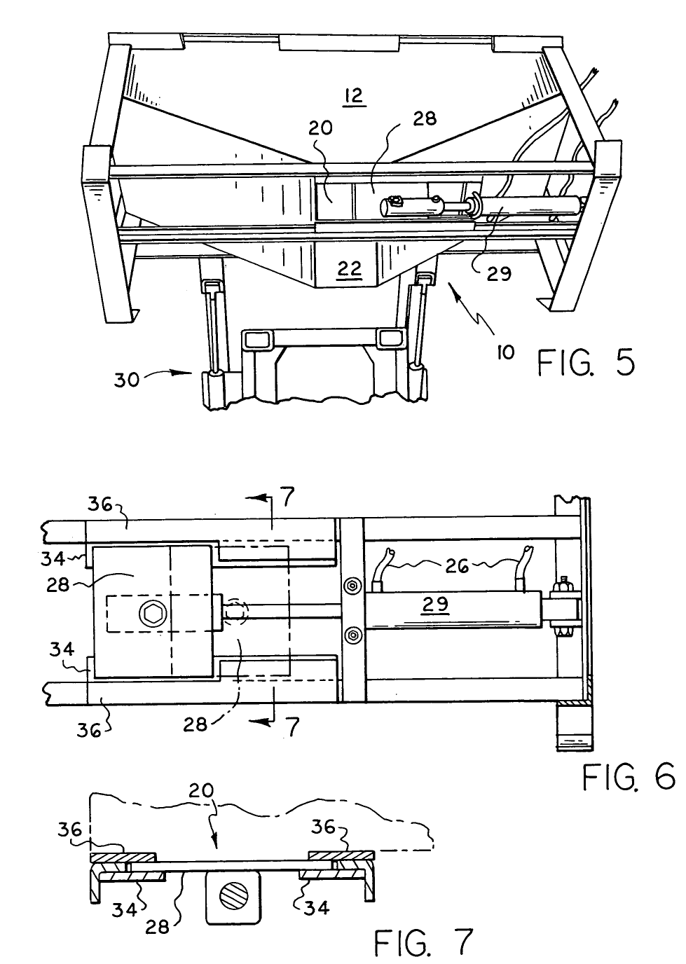

With reference to FIG. 1, loader vehicle 30 is depicted coupled to a bucket apparatus 10. There it can be seen that bucket apparatus 10 is characterized by a generally rectangular opening at the top end, formed by front wall 12, rear wall 18 (depicted in FIG. 2), and the upper vertical portion of sidewalls 14a and 14b. The lower inwardly-sloped portions of sidewalls 16a and 16b, are directed to bottom exit opening 20 that is sufficiently large, when opened, to permit the flowable material to exit therethrough (shown in FIG. 5).

FIG. 2 is a side view of bucket apparatus 10 attached to the arms of skid-steer loader vehicle 30. Bucket apparatus 10 has four supporting vertical leg members 24 which allow the bucket apparatus to stand alone without the support of the loader vehicle. In one preferred embodiment the supporting vertical leg members are adjustable so as to allow the placement of flowable material to unlevel ground. In addition, the adjustable vertical leg members allow for various auxiliary devices to be attached to the bottom of bucket apparatus 10, such as a salt dispenser and the like.

The supporting vertical leg members can support the bucket apparatus during the filling and unloading operation while disconnected from the loader vehicle. Although not depicted, bucket apparatus 10 may be fitted with a lid to prevent its contents from spilling over the sides while moving to a pour site. In addition, a bucket apparatus fitted with a lid functions as a storage bin.

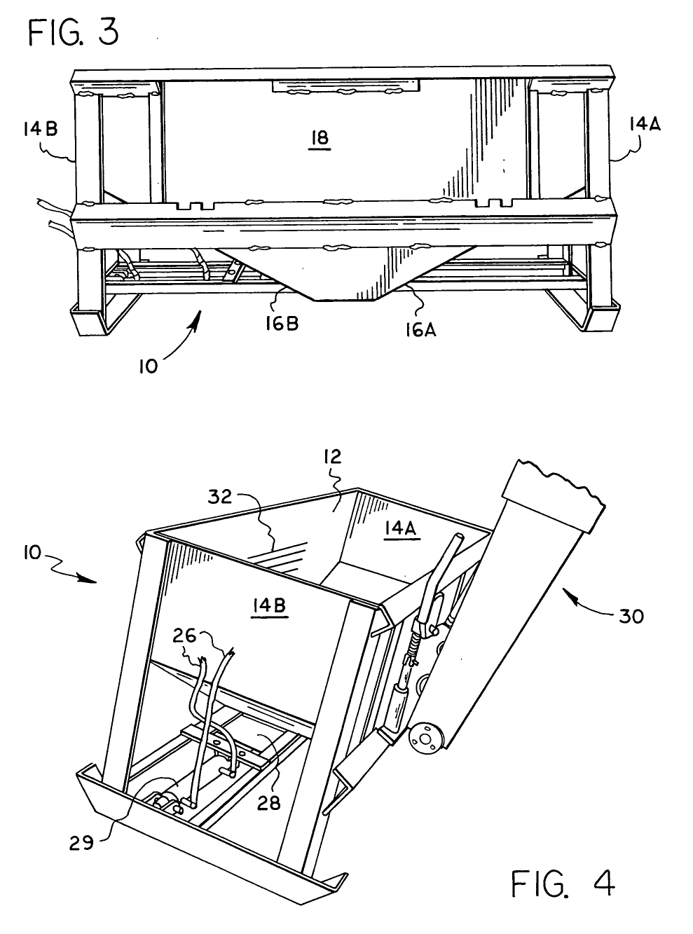

In the preferred embodiment the bucket apparatus 10 has rear wall 18, as shown in FIG. 3, adapted to be removably affixed to loader vehicle 30. The side walls 14 and 16, are connected to the front and back walls and linearly converge toward one another, terminating in a narrow bottom wall 22 (shown in FIG. 5), having exit opening 20 therein. In this way, bucket apparatus 10 narrows from top to bottom and the side walls act as funnel or channel that directs the flowable material to the exit opening 20.

FIG. 4 shows a side view of bucket apparatus 10 having gate 28 and gate control means 29. As is well known in the art, loader vehicles, such as a skid steer loader, are typically fitted with universal hydraulic controls for use with auxiliary hydraulic devices. In a preferred embodiment hydraulic hoses 26 are attached to gate control means 29 at a first end of the hoses and to universal controls (not shown) in the loader vehicle at a second end of the hoses. The figures show the second end of hydraulic hoses 26 in a pre-connection position.

Preferably, the height of the bucket is limited to the extent that, when the bucket is attached to the loader vehicle, the upper portion of the rear wall is below a line of sight from operator to the exit opening. Thus, the operator will have a clear view of the contents of the bucket during discharge and will be able to see the exit opening when the discharge is complete. In an additional preferred embodiment, as an aid to the filling of the bucket as well as to the pouring operation, the inside of the bucket walls is marked with spaced horizontal calibration markings 32, most preferably in the form of spaced horizontal ridges, the vertical distance between ridges being calibrated to represent selected volumes of the bucket's contents. This embodiment simplifies the filling operation, allowing the convenient filling of the bucket to various selected capacities, which may be based on the amount needed at the pour site, or on the size or weight capacity of the loader vehicle, for example, to accommodate various classes of loader vehicles.

FIG. 5 is a bottom view of bucket apparatus 10 illustrating exit opening 20 with gate 28 in the open position. Preferably, side walls 16a and 16b are sloped equally so that bottom wall 22 and opening 20 are centrally positioned. Furthermore, it is preferred that exit opening 20 is positioned at the front of bucket apparatus 10, that is, adjacent front wall 12 and bottom wall 22 is adjacent rear wall 18. The placement of the opening proximate the front wall of the bucket apparatus allows the operator to position the loader to deposit the material with precision and accuracy. During operation, an opening proximate the front wall of the bucket apparatus can be positioned adjacent to a standing wall, post or an immovable object and the like. While exit opening 20 is shown to be roughly centered between side walls 14a and 14b and positioned proximate front wall 12, it is expected that other embodiments will employ an exit opening 20 situated to one side or off center. One such embodiment uses a side exit opening to accommodate the delivery of granular feed to a lengthy livestock feed trough as the loader vehicle moves alongside the trough (not depicted). This side exit opening is configured with an extending chute, commonly known as an “elephant chute.” In another preferred embodiment of the instant invention exit opening 20 is configured with a hose attachment capable of directing the flowable material to a specific area distal to the bucket apparatus (not depicted). Still another preferred embodiment employs a spinner and spreader device to control the discharge of the flowable material. The spinner is operatively arranged in conjunction with a spreader to discharge granular material such as road salt or grass seed across a wide area. The spinner and spreading device is positioned below exit opening 20 and is typically powered by an electric motor (not depicted).

FIG. 6 is an enlarged top view of gate 28 and gate control means 29 of a bucket apparatus 10 of the invention taken generally along line 6-6 in FIG. 1. This illustration shows gate 28 in the closed position and phantom gate 28 in the open position. Exit opening 20 may be selectively opened and closed using gate 28. When gate 28 is moved into the closed position the flowable material is contained within the bucket. When the gate is moved into the open position its outermost edges are surrounded by opposing walls 34 and 36 and the gate is cleaned each time it's opened and closed. Preferably, gate 28 is actuated by a gate control means 29 that the operator may control (not shown) from within the loader vehicle 30. Gate control means 29 allows the operator to selectively control the size of exit opening 20. The size of exit opening 20 determines the rate at which flowable material exits bucket apparatus 10. Optionally, gate 28 may also be opened and closed manually. While the preferred embodiment of the invention employs gate control means 29 (a hydraulic cylinder coupled to the universal hydraulic system of loader vehicle 30) to selectively open and close gate 28, it should be obvious that other suitable means to selectively open and close gate 28 are used, including, for example mechanical, electrical, or pneumatic devices.

FIG. 7 is a cross sectional view of a bottom of an embodiment of a bucket apparatus illustrating exit opening 20 configured with opposing walls 34 and 36 to accommodate the sliding motion of gate 28, taken generally along line 7-7 in FIG. 6. The opposing walls are preferably formed into a grooves or channels which function as a support and accommodates the sliding motion of the flat metal sheet plate which comprises gate 28. Gate 28 is controllably slidable across the exit opening to determine the size of the exit opening and the discharge of flowable materials from the bucket. Gate 28 is operatively arranged to open or close exit opening 20 by sliding into and out of the opening while bucket apparatus 10 is full of a flowable material. Gate 28 is a sliding self cleaning gate that that permits multiple opening and closing of exit opening 20 without clogging the exit opening. Others have attempted to provide a dispensing apparatus with other gate mechanisms meant to control discharge of flowable material therefrom, but those gate mechanisms encounter problems with interrupted flow.

Although the invention has been described with reference to certain preferred embodiments, it will be appreciated by those skilled in the art that modifications and variations may be made without departing from the spirit and scope of the invention.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A bucket, removably attachable to a loader vehicle for the transport and discharge of flowable materials said bucket comprising
a front wall and opposing rear wall, and opposing sidewalls defining, at a top end thereof, a rectangular opening for the loading of flowable materials into said bucket, said opposing sidewalls, having at least a lower portion thereof, being sloped to form a hopper configuration terminating at a lower end in a bottom exit opening adapted for the controllable discharge of said flowable materials from said bucket.

2. A bucket according to claim 1 wherein the size of said exit opening and the discharge of flowable materials from said bucket is controlled by a gate controllably slidable across said exit opening.

3. A bucket according to claim 2 wherein said gate is manually slidable across said exit opening.

4. A bucket according to claim 2 wherein said gate is controllably slidable across said exit opening by a hydraulic power system controlled by an operator of said loader vehicle.

5. A bucket according to claim 2 having four supporting vertical leg members.

6. A bucket according to claim 5 wherein said vertical leg members include means for adjustment of height.

7. A bucket according to claim 2 wherein said exit opening is positioned adjacent to a lower end of said front wall.

8. A bucket according to claim 2 having a removable protective cover adapted to fit over said rectangular opening.

9. A bucket according to claim 2 wherein at least a part of said upper portion of said rear wall is limited in height to an extent that said operator is provided with a clear line of sight to the surface of the contents of said bucket and to said exit opening when said bucket is empty.

10. A bucket according to claim 9 wherein the inside of said walls includes calibration markings to represent selected volumes.

11. A bucket according to claim 10 wherein said calibration markings are in the form of raised ridges.

12. A bucket according to claim 10 wherein said exit opening is in the form of an extending chute.

13. A bucket according to claim 10 wherein said exit opening is in the form of a hose.

14. A bucket according to claim 10 wherein the discharge of flowable materials from said bucket is controlled by a spinner positioned below said exit opening.

15. A bucket according to claim 14 wherein said spinner is controlled by an electric motor.

16. A bucket according to claim 2 wherein said exit opening is configured with grooves that accommodate said gate and wherein said gate is a sliding self cleaning gate.

17. A bucket, removably attachable to a skidsteer loader vehicle for the transport and discharge of flowable materials, said bucket comprising
a front wall and opposing rear wall, and opposing sidewalls defining, at a top end thereof, a rectangular opening for the loading of flowable materials into said bucket;
a removable protective cover adapted to fit over said rectangular opening;
said opposing sidewalls, in at least a lower portion thereof, being sloped to form a hopper configuration terminating at a lower end in a bottom exit opening positioned adjacent a lower end of said front wall;
a gate, horizontally slidable across said exit opening, for the control of discharge of said flowable materials through said exit opening; and
four adjustable supporting vertical leg members.
